(19) United States
(12) Patent Application Publication
(10) Pub. No.: US 2024/0302140 A1
(43) Pub. Date: Sep. 12, 2024

(54) Ballistic Shield Assembly

(71) Applicant: Dean Chester Mickiewicz, Helena, AL (US)

(72) Inventor: Dean Chester Mickiewicz, Helena, AL (US)

(21) Appl. No.: 18/179,918

(22) Filed: Mar. 7, 2023

(51) Int. Cl. F41H 5/08; F16M 11/02; F16M 11/20

(52) U.S. Cl. CPC F41H 5/08; F16M 11/02; F16M 11/2021; F16M 11/2092

(57) ABSTRACT

This invention solves the problem of a ballistic shield laying further away from the user when using a long gun by placing a support arm in the direction away from the user. The arm provides the forward support and balance to the long gun. This invention also solves the problem of having fasteners which attach the handle, carrying straps and related hardware directly exposed to incoming bullets by using a detachable ballistic panel assembly.

### RELATED APPLICATIONS

Provisional application No. 63/372,467, filed on Mar. 15, 2022 and now abandoned.

### BACKGROUND OF THE INVENTION

### 1. Field of the Invention

The present invention is for man portable (hand held ballistic shields), but may be used for non man portable shields.

### 2. Description of Related Art

Ballistic shields are used anywhere that a ballistic threat is possible. The main users are security, law enforcement and military. Typically ballistic shields are not meant to replace personal body armor (such as vests), but to add additional protection over areas not protected by a vest and to provide additional protection over areas already protected by the user's body armor.

Ballistic shields (ballistic plates designed to stop or significantly reduce the trauma from high velocity projectiles-such as bullets) are typically one piece. Shields for coverage over the head and chest areas are usually larger and heavy enough such that they are not carried for routine use and thus not available when the threat occurs.

Extended boy (Head and chest front, pubic region front, upper leg) coverage with existing ballistic shields usually are large one piece shields. Shields of this type must be stored in larger containment areas, such as the trunk of a police car. Smaller ballistic shields (for head and neck protection) do not exist that can also have other ballistic plates (such as an extension panel to increase ballistic coverage) attached later for extended body (if needed) coverage.

Currently, ballistic shield manufacturers have come up with their own methods of supporting a long gun with a ballistic shield, and making holding the weight of the shield easier. One manufacturer has a backpack with a rigid arm cantilevered from the backpack, over the head of the user and attached to the shield, to support its weight. This manufacturer uses the shield as the second support point to support and balance the weight of the long gun. Thus, the shield must be placed further away from the user's body, which then provides less coverage to the user.

Ballistic shields are typically of a one piece construction. The ballistic material is directly connected to the handle, nameplate and similar features such that if a bullet hit the fastener which connected the handle to the ballistic material, the handle may become loose and cause the shield to fall.

### SUMMARY OF THE INVENTION

In accordance with this invention, there is a least one ballistic plate which contains ballistic material. This ballistic plate may have a handle and typical features found on many ballistic shields, such as a viewport. The ballistic plate may only have features to connect to a secondary plate. This secondary plate (base plate) may contain the handle, connections to carrying straps and other features found on ballistic shields.

On the back side (non-impact side) of the ballistic plate are placed components which enable the main ballistic plate to be fastened to the base plate. These components may be attached to the main ballistic plate by fasteners as long as the fasteners are not protruding through the entire main ballistic plate such that they are not directly exposed to the impact of bullets. Other means of attaching the components to the main ballistic plate, such as gluing or using epoxy resins are acceptable.

A further implementation with this invention is the space between the main ballistic plate and the base plate. This gap creates space armor, a useful component of many armor systems. The armor is removeable such that it can be replaced in the field and the other components of the ballistic shield mounted on the base plate, such as the handle can be used again after the main ballistic plate has been degraded due to stopping bullets.

One plate, either ballistic or an attached plate, has a structural member attached to it which is to be used as a support point for a long gun. This structural member supports the weight of the long gun at a point at least 2.5 inches away from the main ballistic plate, in the same direction as the long gun is aiming.

A further implementation of this invention is the close proximity of the user's hand holding the shield to the user's body. When the user is holding both the shield in one hand and the long gun with the other hand, the hand holding the handle of the shield may be in closer proximity to the user's chest, when the user is aiming the long gun with the structural member supporting and balancing the weight of the long gun.

Another implementation coherent with the principles of this invention is that the structural support arm for the long gun may be adjustable in length and can rotate for storage.

### BRIEF DESCRIPTION OF THE DRAWINGS

For a fuller understanding of the nature and object of the invention, reference should be had to the following detailed description taken in connection with the accompanying drawings in which:

FIG. 1 is an exploded front perspective view of the ballistic shield of the present invention including the long gun support.

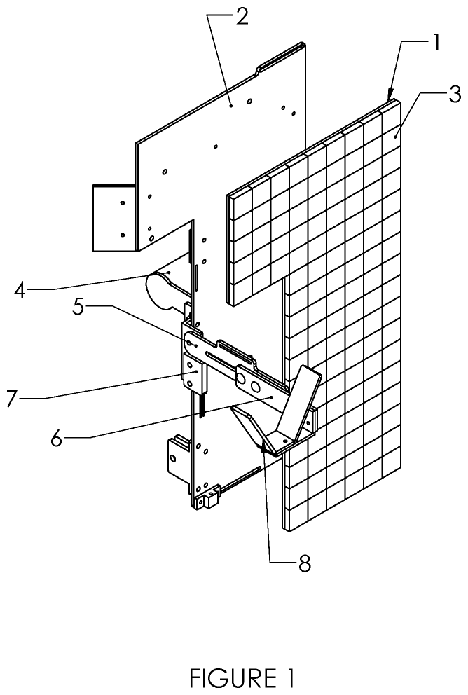

FIG. 2 is a rear perspective view of the ballistic shield of the present invention including the long gun support in the deployed position.

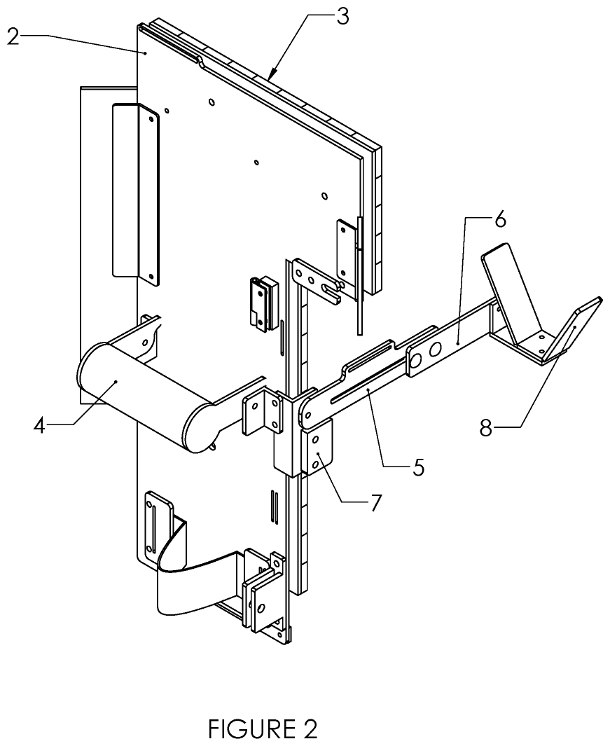

FIG. 3 is a side view of the ballistic shield of the present invention including the long gun support in the retracted or stowed position.

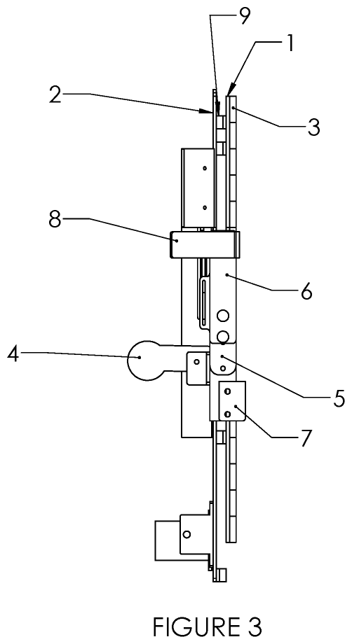

FIG. 4 is a detailed perspective view of the long gun support of the present invention in the extended or deployed position.

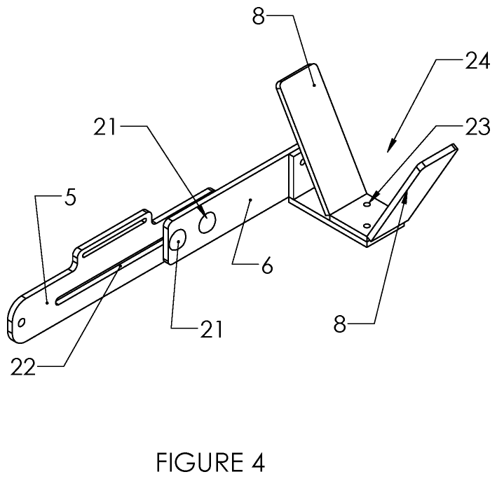

FIG. 5 is a front view of the ballistic plate of the present invention.

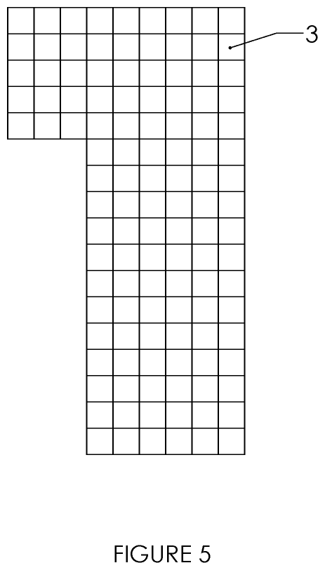

FIG. 6 is a rear view of the back plate of the present invention.

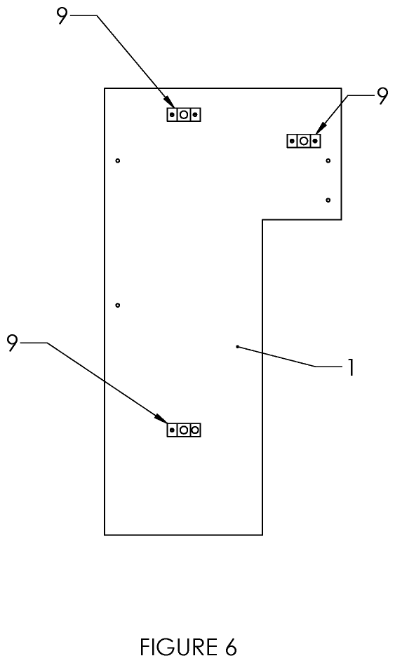

FIG. 7 is a partial side view of the ballistic shield of the present invention.

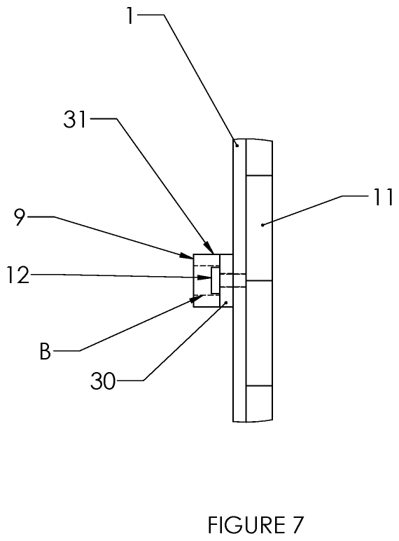

FIG. 8A is a view of the back plate connector of the present invention.

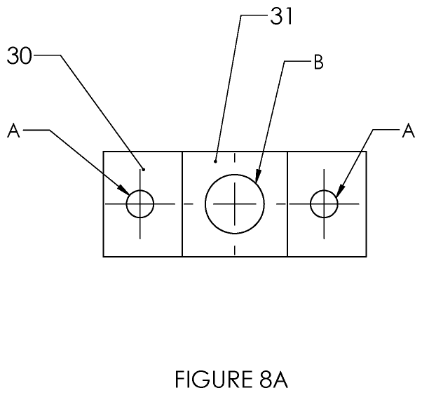

FIG. 8B is a side view of the back plate connector of the present invention.

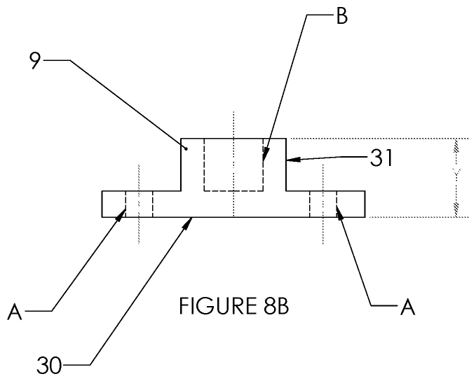

FIG. 9 is an exploded side view of the connector assembly of the present invention.

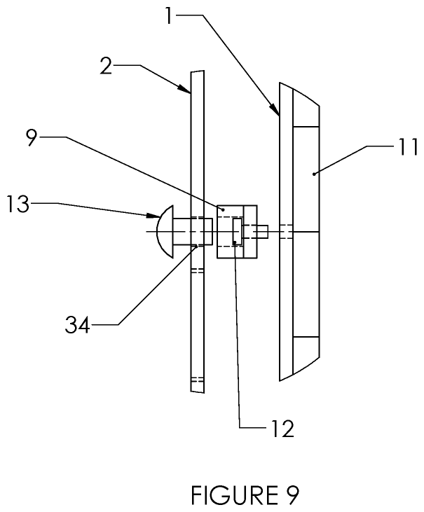

Similar reference characters refer to similar parts throughout the several views of the drawings.

What is claimed:

1. A ballistic shield assembly configured to protect law enforcement personnel from bullets, said ballistic shield assembly comprising a back plate including a front surface having a protective ballistic shield including a back surface and a front surface attached to said front surface of said back plate and a long gun support mounted to said back plate to support the distal end portion of the long gun of a person positioned behind the ballistic shield assembly.

2. The ballistic shield assembly of claim 1 wherein said long gun support comprises a proximal support member movable between a stowed position and a deployed position pivotally coupled to said back plate such that said proximal support member is disposed in a plane rearward of said front surface of said protective ballistic shield when in said stowed position and extends outwardly relative to said front surface of said protective ballistic shield when in said deployed position.

3. The ballistic shield assembly of claim 2 wherein said proximal support member is disposed substantially parallel to said back plate when in said stowed position and is disposed substantially perpendicular to said back plate when in said deployed position.

4. The ballistic shield assembly of claim 2 wherein said long gun support further includes a distal support member movable between a stowed position and a deployed position such that said distal support member is disposed substantially parallel side by side relationship with said proximal support member when each is in said stowed position and said distal support member is adjustably coupled to said proximal support member to extend said distal support member outwardly from said proximal support member relative to said back plate when said proximal support member and said distal support member are each in said deployed position.

5. The ballistic shield assembly of claim 2 further including a stop attached to said base plate to engage said proximal support member when said proximal support member is in said deployed position.

6. The ballistic shield assembly of claim 4 further including a barrel support attached to said distal support member to support the distal portion of the barrel of the long gun when said distal support member is in said deployed and extended positions.

7. The ballistic shield assembly of claim 6 wherein said barrel support comprises a barrel support plate having a limit formed on each side thereof to restrict lateral movement of the barrel of the long gun when resting on said barrel support plate.

8. The ballistic shield assembly of claim 1 wherein said protective ballistic shield is detachably coupled to said back plate to permit replacement of said protective ballistic plate.

9. The ballistic shield assembly of claim 8 including at least one connector attached to said back surface of said protective ballistic shield to detachably couple said protective ballistic shield to said back plate.

10. The ballistic shield assembly of claim 9 wherein said connector comprises a post having a recess formed therein to receive a fastener to detachably secure said protective ballistic shield to said back plate.

11. The ballistic shield assembly of claim 1 wherein said protective ballistic shield comprises an outer ballistic plate and an inner backing plate.

12. A ballistic shield assembly configured to protect law enforcement personnel from bullets, said ballistic shield assembly comprising a back plate including a front surface having a protective ballistic shield including a back surface and a front surface, said protective ballistic shield being detachable attached to said front surface of said back plate to permit replacement of said protective ballistic shield.

13. The ballistic shield assembly of claim 12 wherein said ballistic shield assembly of claim 12 include at least one connector attached to said back surface of said protective ballistic shield to detachably couple said protective ballistic shield to said back plate.

14. The ballistic shield assembly of claim 13 wherein said ballistic shield assembly of claim 13 wherein said connector comprises a post having a recess formed therein to receive a fastener to detachably secure said protective ballistic shield to said back plate.

15. The ballistic shield assembly of claim 12 wherein said protective ballistic shield comprises an outer ballistic plate and an inner backing plate.

16. The ballistic shield assembly of claim 4 further including a stop attached to said base plate to engage said proximal support member when said proximal support member and said distal support member are each in said deployed position.
